(19) United States
(12) Patent Application Publication
(10) Pub. No.: US 2008/0261692 A1
(43) Pub. Date: Oct. 23, 2008

(54) VIDEO GAME PROGRAM, VIDEO GAME DEVICE, AND VIDEO GAME CONTROL METHOD

(75) Inventor: Katsuyoshi Endo, Osaka (JP)

Correspondence Address: GLOBAL IP COUNSELORS, LLP, 1233 20TH STREET, NW, SUITE 700, WASHINGTON, DC, 20036-2680, US

(73) Assignee: KONAMI DIGITAL ENTERTAINMENT CO., LTD., Tokyo (JP)

(21) Appl. No.: 12/139,897

(22) Filed: Jun. 16, 2008

Related U.S. Application Data
(63) Continuation of application No. PCT/JP2006/321237, filed on Oct. 25, 2006.

(30) Foreign Application Priority Data
Dec. 26, 2005 (JP) 2005-372071

(51) Int. Cl. A63F 13/00

(52) U.S. Cl. 463/31; 463/43

(57) ABSTRACT

According to the present game program, the velocity magnitude data of a controller and velocity magnitude data of an object are calculated based on the acceleration data and the time duration data, both of which are recognized by a control unit. Then, the calculation of modifying the range data of the area into the range data depending on the velocity magnitude of the object is performed. Accordingly, an area set by the modified range data of the area is displayed on a television monitor with the image data. Finally, a state of the object moving at the velocity set by the velocity magnitude data of the object is consecutively displayed on the television monitor with the image data corresponding to the object.

### CROSS-REFERENCE TO THE RELATED APPLICATION

This application claims priority to Japanese Patent Application No. 2005-372071 and International Patent Application No. PCT/JP2006/321237. The entire disclosure of Japanese Patent Application No. 2005-372071 and International Patent Application No. PCT/JP2006/321237 is hereby incorporated herein by reference.

### BACKGROUND OF THE INVENTION

1. Technical Field

The preset invention relates to a video game program, particularly to a video game program for causing a computer to realize a video game in which an object and an area changing in conjunction with movement of the object are displayed on an image display unit and the object is moved in conjunction with movement of a controller in which an acceleration sensor is embedded based on the acceleration data detected by the acceleration sensor and accordingly the area is changed. Also, the present invention relates to a video game device that is capable of executing the video game to be realized by the video game program, and relates to a video game control method for allowing a computer to control the video game to be realized by the video game program.

2. Background Art

Various video games have been proposed in the past. The video games are configured to be executed in a game device. For example, a general game device includes a monitor, a game console that is provided separately from the monitor, and an input unit (e.g., a controller) that is provided separately from the game console. An input part (e.g., a plurality of input buttons) is disposed on the controller. A game device of this type is configured to be capable of causing an object displayed on the monitor to perform an action by manipulating the input buttons.

A situation is hereinafter considered that a versus-type game (e.g., baseball game) is executed in a game device of this type. In the baseball game, it is possible to cause an object displayed on a monitor (e.g., a bat of a batter character) to perform an action by manipulating input buttons. JIKKYOU PAWAFURU PURO YAKYU 9 KETTEIBAN, Konami Corporation, for PS2 discloses such game as an example. In this case, first of all, either a contact hitting cursor for a normal swing or a contact hitting cursor for a powerful swing is selected by pressing a contact hitting cursor selection button. Then, when up, down, right, and left portions of a cross-shaped button are pressed, a contact hitting cursor accordingly moves up, down, right, and left. Next, if an X button is pressed so that a bat is capable of hitting a ball when the ball released by a pitcher character reaches a ball passing position on a hitting surface, the batter character starts swinging the bat. Accordingly, the bat displayed on the monitor starts moving at the constant velocity. Then, when the pitched ball is positioned within the area of the contact hitting cursor on the hitting surface, the pitched ball is hit back with the bat. Here, the ball hit back with the bat when the contact hitting cursor for the powerful swing is selected flies to the fielder side at the velocity faster than the ball hit back with the bat when the contact hitting cursor for the normal swing is selected.

### SUMMARY OF THE INVENTION

In the conventional baseball game, either the contact hitting cursor for the normal swing (contact hitting cursor with large area) or the contact hitting cursor for the powerful swing (contact hitting cursor with small area) is configured to be selected by pressing the contact hitting cursor selection button. Also, the ball hit back with the bat when the contact hitting cursor with the powerful swing is selected is configured to fly to the fielder side at the velocity faster than the ball hit back with the bat when the contact hitting cursor for the normal swing is selected.

Even though whether a batter powerfully hits a pitched ball or the batter normally hits the pitched ball depends on the swing velocity of the batter in the real baseball, whether a batter character powerfully hits a ball or the batter character normally hits the ball is configured to be selected by the contact hitting cursor selection button regardless of the swing velocity of the batter character in the conventional baseball game. This is because the conventional baseball game did not have a function or means for evaluating relation between the swing velocity of the batter character and the contact hitting cursor. In other words, in the conventional baseball game, it has been difficult to instruct the batter character to powerfully hit the ball or normally hit the ball in consideration of the relation between the swing velocity of the batter character and the contact hitting cursor.

An object of the present invention is to make it possible to cause an object (bat) to move based on the acceleration data detected by an acceleration sensor embedded in a controller and cause an area (contact hitting cursor area) associated with the object (bat) to change in conjunction with movement of the object (bat).

A video game program in accordance with a first aspect of the present invention is a program for causing a computer, which is configured to be capable of executing a video game in which an object and an area changing in conjunction with movement of the object are displayed on an image display unit and the object is moved based on the acceleration data detected by an acceleration sensor in conjunction with movement of a controller in which the acceleration sensor is embedded and the area is accordingly changed, to realize the following functions.

(1) An acceleration data recognizing function for causing a control unit to recognize the acceleration data to be consecutively inputted into an input unit.

(2) A time duration data recognizing function for causing the control unit to recognize time duration of the acceleration data to be consecutively inputted into the input unit as time duration data.

(3) A velocity data calculating function for causing the control unit to calculate the velocity magnitude (speed) data of the controller based on the acceleration data and the time duration data, both of which are recognized by the control unit.

(4) An object moving velocity data calculating function for causing the control unit to calculate the velocity magnitude data of the object based on the velocity magnitude data of the controller.

(5) A range data recognizing function for causing the control unit to recognize range data of the area.

(6) A range displaying function for displaying an area set by the range data of the area on the image display unit with image data.

(7) A range data modifying function for causing the control unit to perform the calculation of modifying the range data of the area into the range data of changing the range of the area depending on the velocity magnitude of the object.

(8) A modified area displaying function for displaying an area set by the modified range data of the area on the image display unit with image data.

(9) An object moving state displaying function for consecutively displaying a state of the object moving at the velocity set by the velocity magnitude data of the object on the image display unit with the image data corresponding to the object.

According to the game realized by the program, in the acceleration data recognizing function, the acceleration data to be consecutively inputted into the input unit is recognized by the control unit. In the time duration data recognizing function, the time duration of the acceleration data to be consecutively inputted into the input unit is recognized by the control unit as the time duration data. In the velocity data calculating function, the velocity magnitude data of the controller is calculated by the control unit based on the acceleration data and the time duration data, both of which are recognized by the control unit. In the object moving velocity data calculating function, the velocity magnitude data of the object is calculated by the control unit based on the velocity magnitude data of the controller. In the range data recognizing function, the range data of the area is recognized by the control unit. In the area displaying function, the area set by the range data of the area is displayed on the image display unit with the image data. In the range data modifying function, the calculation of modifying the range data of the area into the range data of changing the range of the area depending on the velocity magnitude of the object is performed by the control unit. In the modified area displaying function, the area set by the modified range data of the area is displayed on the image display unit with the image data. In the object moving state displaying function, the state of the object moving at the velocity set by the velocity magnitude data of the object is consecutively displayed on the image display unit with the image data corresponding to the object.

When a baseball game to be realized by the game program is exemplified, first, the acceleration data to be consecutively inputted into the input unit from the controller is recognized by the control unit. Then, time duration of the acceleration data to be consecutively inputted into the input unit from the controller is recognized by the control unit as the time duration data. Next, the velocity magnitude data of the controller is calculated by the control unit based on the acceleration data and the time duration data, both of which are recognized by the control unit. Accordingly, the velocity magnitude data of the object (e.g., bat) is calculated by the control unit based on the velocity magnitude data of the controller. Subsequently, the range data of the area (e.g., contact hitting cursor area) is recognized by the control unit. Accordingly, the contact hitting cursor area set by the range data of the contact hitting cursor area is displayed on the image display unit with the image data. Then, the calculation of modifying the range data of the contact hitting cursor area into the range data of changing the range of the contact hitting cursor area depending on the velocity magnitude of the bat is performed by the control unit. Accordingly, the contact hitting cursor area set by the modified range data of the contact hitting cursor area is displayed on the image display unit with the image data. Finally, the state of the bat moving at the velocity set by the velocity magnitude data of the bat is consecutively displayed on the image display unit with the image data corresponding to the bat.

In the game program, with the controller in which the acceleration sensor is embedded, it is possible to change the contact hitting cursor area set by the range data of the contact hitting cursor area depending on the velocity magnitude of the bat. In other words, it is possible to change the contact hitting cursor area in conjunction with movement of the bat by moving the controller.

A video game program in accordance with a second aspect of the present invention is the game program of the first aspect, and the following functions are realized. According to the game program, in the range data modifying function, the calculation of modifying the range data of the area into the range data of reducing the range of the area depending on the velocity magnitude of the object when the velocity set by the velocity magnitude data of the object is greater than the reference velocity set by the reference velocity magnitude data of the object is performed by the control unit. Then, the calculation of modifying the range data of the area into the range data of expanding the range of the area depending on the velocity magnitude of the object is performed by the control unit when the velocity set by the velocity magnitude data of the object is less than the reference velocity set by the reference velocity magnitude data of the object.

In the game program, when the velocity set by the velocity magnitude data of the object is less than or greater than the reference velocity set by the reference velocity magnitude data of the object, the calculation of modifying the range data of the area into the range data of expanding or reducing the range of the area depending on the velocity magnitude of the object is performed by the control unit. For example, in the baseball game to be realized by the game program, when the velocity of the bat is slower than the reference velocity, the range data of the contact hitting cursor area is modified so that the contact hitting cursor area is enlarged. On the other hand, when the velocity of the bat is faster than the reference velocity, the range data of the contact hitting cursor area is modified so that the contact hitting cursor area is reduced. With the modification, it is possible to cause the contact hitting cursor area to change depending on the velocity magnitude of the bat. In other words, it is possible to change the contact hitting cursor area in conjunction with movement of the bat by moving the controller.

A video game program in accordance with a third aspect of the present invention is the game program of the first aspect, and the following functions are realized. According to the game program, in the range data modification function, the calculation for modifying the range data of the area depending on the ratio of the velocity of the object with respect to the reference velocity of the object is performed by the control unit.

For example, in the baseball game to be realized by the game program, the range data of the contact hitting cursor area is modified depending on the ratio of the velocity of the bat with respect to the reference velocity of the bat. With the modification, it is possible to change the contact hitting cursor area depending on the velocity magnitude of the bat. In other words, it is possible to change the contact hitting cursor area in conjunction with movement of the bat by moving the controller.

A video game program in accordance with a fourth aspect of the present invention is the game program of the first aspect, and is a program for causing a computer, which is configured to be capable of realizing a video game in which an object and an area changing in conjunction with movement of the object are displayed on an image display unit and the object is moved based on the acceleration data detected by an acceleration sensor in conjunction with movement of a controller in which the acceleration sensor is embedded and the area is accordingly changed, to realize the following functions.

(10) A moving object position recognizing function for causing the control unit to recognize the position data of a moving object (second object) that is in motion.

(11) A moving object velocity recognizing function for causing the control unit to recognize the velocity magnitude data of the moving object that is in motion.

(12) A coordinate correspondence judging function for causing the control unit to judge whether or not the coordinate within the range of the area set by the modified range data of the area corresponds to at least one of the coordinates within the area of the moving object set by the position data of the moving object.

(13) A moving object moving velocity modifying function for causing the control unit to perform the calculation of modifying the velocity magnitude data of the moving object depending on distance between a reference point in the area set by the modified range data of the area and a reference point of the moving object set by the position data of the moving object when it is judged by the control unit that the coordinate within the range of the area set by the modified range data of the area corresponds to at least one of the coordinates within the area of the moving object set by the position data of the moving object.

(14) A moving object moving state displaying function for consecutively displaying a state of the moving object moving at the velocity set by the modified velocity magnitude data of the moving object on the image display unit with image data corresponding to the moving object.

According to the game to be realized by the program, in the moving object position recognizing function, the position data of the moving object that is in motion is recognized by the control unit. In the moving object velocity recognizing function, the velocity magnitude data of the moving object that is in motion is recognized by the control unit. In the coordinate correspondence judging function, it is judged by the control unit whether or not the coordinate within the range of the area set by the modified range data of the area corresponds to at least one of the coordinates within the area of the moving object set by the position data of the moving object. In the moving object moving velocity modifying function, if it is judged by the control unit that the coordinate within the range of the area set by the modified range data of the area corresponds to at least one of the coordinates within the area of the moving object set by the position data of the moving object, the calculation of modifying the velocity magnitude data of the moving object is performed by the control unit depending on distance between the reference point of the area set by the modified range data of the area and the reference point of the moving object set by the position data of the moving object. In the moving object moving state displaying function, a state of the moving object moving at the velocity set by the modified velocity magnitude data of the moving object is consecutively displayed on the image display unit with the image data corresponding to the moving object.

When a baseball game to be realized by the game program is exemplified, the position data of the ball that is in motion and the velocity magnitude data of the ball are recognized by the control unit. Then, it is judged by the control unit whether or not the coordinate within the range of the contact hitting cursor area set by the modified range data of the contact hitting cursor area corresponds to at least one of the coordinates within the area of the ball set by the position data of the ball. Next, if it is judged by the control unit that the coordinate within the range of the contact hitting cursor area set by the modified range data of the contact hitting cursor area corresponds to at least one of the coordinates within the area of the ball set by the position data of the ball, the calculation of modifying the velocity magnitude data of the ball is performed by the control unit depending on distance between the reference point of the contact hitting cursor area set by the modified range data of the contact hitting cursor area and the reference point of the ball set by the position data of the ball. Accordingly, a state of the ball moving at the velocity set by the modified velocity magnitude data of the ball is consecutively displayed on the image display unit with the image data corresponding to the ball.

In the game program, when it is judged by the control unit that the coordinate within the range of the contact hitting cursor area corresponds to at least one of the coordinates within the area of the ball, that is, when the ball is hit with the bat, the velocity magnitude of the ball is modified depending on distance between the reference point of the contact hitting cursor area and the reference point of the ball, and a state of the ball moving at the modified velocity of the ball is consecutively displayed on the image display unit. Accordingly, it is possible to modify the velocity of the ball hit back with the bat depending on the distance between the reference point of the contact hitting cursor area and the reference point of the ball, and it is possible to display a state of the ball moving at the modified velocity of the ball on the image display unit. For example, if the ball is hit back with the bat under the condition that the distance between the reference point of the contact hitting cursor area and the reference point of the ball is small, a state of the ball moving faster than the velocity at which the ball moves when the ball is hit back with the bat under the condition that the distance between the reference point of the contact hitting cursor area and the reference point of the ball is small.

A video game program in accordance with a fifth aspect of the present invention is the game program of the fourth aspect, and the following functions are realized. According to the game program, in the moving object moving velocity modifying function, the calculation of modifying the velocity magnitude data of the moving object depending on the velocity magnitude of the object is performed by the control unit when it is judged by the control unit that the coordinate within the range of an area set by the modified range data of the area corresponds to at least one of the coordinates within the area of the moving object set by the position data of the moving object.

For example, in the baseball game to be realized by the game program, the velocity magnitude data of the ball is modified depending on the velocity magnitude of the bat and a state of the ball moving at the modified velocity of the ball is consecutively displayed on the image display unit when it is judged by the control unit that the coordinate within the modified range of the contact hitting cursor area corresponds to at least one of the coordinates within the area of the ball, that is, when the ball is hit with the bat. For example, when the ball is hit back with the bat under the condition that the velocity of the bat is large, a state of the ball moving faster than the velocity at which the ball moves when the ball is hit back with the bat under the condition that the velocity of the bat is small is displayed on the image display unit.

A video game device in accordance with a sixth aspect of the present invention is a video game device that is configured to be capable of executing a video game in which an object and an area changing in conjunction with movement of the object are displayed on an image display unit and the object is moved based on the acceleration data detected by an acceleration sensor in conjunction with movement of a controller in which the acceleration sensor is embedded and the area is accordingly changed. The video game device includes acceleration data recognizing means for causing a control unit to recognize the acceleration data to be consecutively inputted into an input unit, time duration data recognizing means for causing the control unit to recognize time duration of the acceleration data to be consecutively inputted into the input unit as time duration data, velocity data calculating means for causing the control unit to calculate the velocity magnitude data of the controller based on the acceleration data and the time duration data, both of which are recognized by the control unit, object moving velocity data calculating means for causing the control unit to calculate the velocity magnitude data of the object based on the velocity magnitude data of the controller, range data recognizing means for causing the control unit to recognize range data of the area, range displaying means for displaying an area set by the range data of the area on the image display unit with image data, range data modifying means for causing the control unit to perform the calculation of modifying the range data of the area into the range data of changing the range of the area depending on the velocity magnitude of the object, modified area displaying means for displaying an area set by the modified range data of the area on the image display unit with image data, and object moving state displaying means for consecutively displaying a state of the object moving at the velocity set by the velocity magnitude data of the object on the image display unit with the image data corresponding to the object.

A video game control method in accordance with a seventh aspect of the present invention is a method for controlling a video game by allowing a computer to control a video game in which an object and an area changing in conjunction with movement of the object are displayed on an image display unit and the object is moved based on the acceleration data detected by an acceleration sensor in conjunction with movement of a controller in which the acceleration sensor is embedded and the area is accordingly changed. The video game control method includes A video game control method in accordance with a seventh aspect of the present invention is a method for controlling a video game by allowing a computer to control a video game in which an object and an area changing in conjunction with movement of the object are displayed on an image display unit and the object is moved based on the acceleration data detected by an acceleration sensor in conjunction with movement of a controller in which the acceleration sensor is embedded and the area is accordingly changed. The video game control method includes recognizing time duration of the acceleration, calculating speed of the input unit based on the acceleration and the time duration, calculating speed of the object based on the speed of the input device, recognizing range of the area, displaying the area on an image display unit on the basis of the range; modifying the range to modified range on the basis of the speed of the object, displaying the area on the image display unit on the basis of the modified rang, and displaying the object moving at the speed of the object on the image display unit.

### BRIEF DESCRIPTION OF THE DRAWINGS

Referring now to the attached drawings which form a part of this original disclosure.

FIG. 1 is a diagram of a video game device in accordance with an embodiment of the present invention.

FIG. 2 is a functional block diagram as an example of the video game device.

FIG. 3 is a diagram for illustrating characters displayed on a television monitor.

FIG. 4 is a diagram for illustrating correspondence between a moving state of a controller and a moving state of a bat.

FIG. 5 is a diagram for illustrating relation among the acceleration data, the velocity data, and the position data.

FIG. 6 is a chart for illustrating functional relation when the position data of a controller is converted into the position data for a television monitor.

FIG. 7 is a diagram for illustrating a contact hitting cursor area to be expanded or reduced.

FIG. 8 is a diagram for illustrating a method of calculating distance between a reference point of a ball and that of a bat.

FIG. 9 is a flowchart for illustrating a cooperative system of a bat and a contact hitting cursor.

FIG. 10 is a flowchart for illustrating the cooperative system of a bat and a contact hitting cursor.

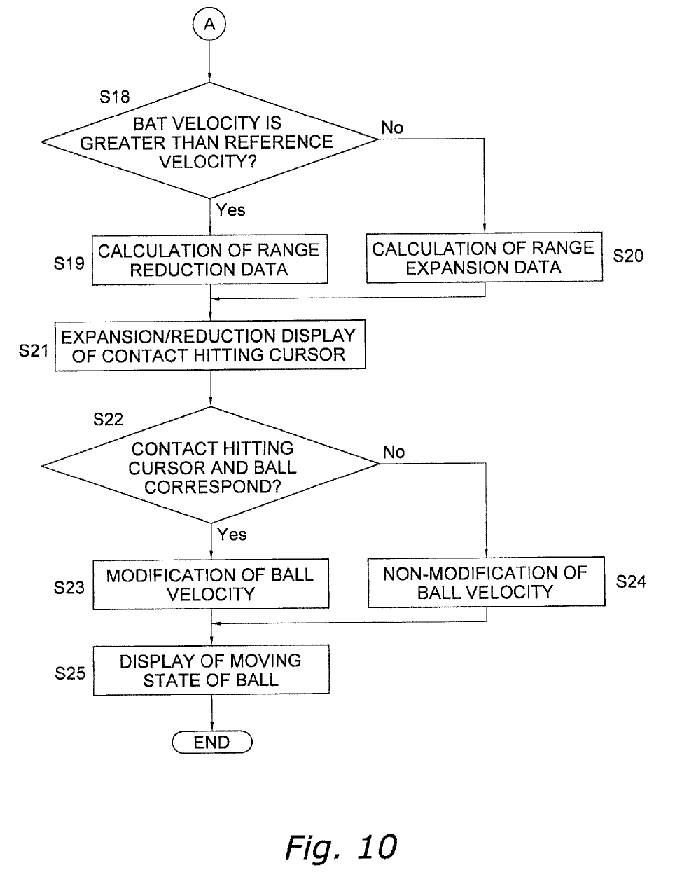

### DETAILED DESCRIPTION OF PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Configuration and Operation of Game Device

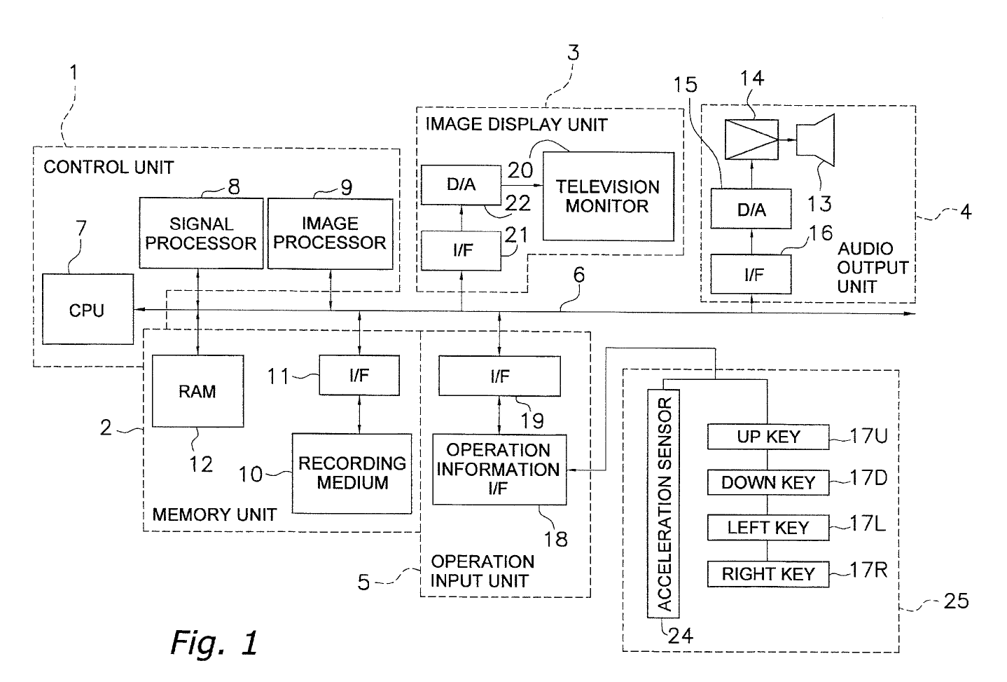

FIG. 1 shows the basic configuration of a game device in accordance with an embodiment of the present invention. As an example of a video game device, a home video game device will be hereinafter explained. The home video game device includes a home video game console and a home television set. A recording medium 10 is configured to be allowed to be loaded in the home video game console. Game data is arbitrarily read out of the recording medium 10 and a game is executed. The content of the game executed herewith is displayed on the home television set.

The game system of the home video game device is made up of a control unit 1, a memory unit 2, an image display unit 3, an audio output unit 4, and an operation input unit 5, and these units are connected to each other through a bus 6. This bus 6 includes an address bus, a data bus, a control bus, and the like. Here, the control unit 1, the memory unit 2, the audio output unit 4, the operation input unit 5, and a controller 25 are included in the home video game console of the home video game device, and the image display unit 3 is included in the home television set.

The control unit 1 is provided for mainly controlling progress of the entire game based on the game program. The control unit 1 is made up of a CPU (Central Processing Unit) 7, a signal processor 8, and an image processor 9, for instance. The CPU 7, the signal processor 8, and the image processor 9 are connected to each other through the bus 6. The CPU 7 interprets a command from a game program and performs a variety of data processing and data control. For example, the CPU 7 commands the signal processor 8 to provide the image data to the image processor. The signal processor 8 mainly performs computations in the three-dimensional space, computations of positional conversion from the three-dimensional space to the virtual three-dimensional space, a light source computation processing, and data generation and data processing of the image data and the audio data. The image processor 9 mainly performs a processing to write the image data to be rendered to a RAM 12 based on the computation results and processing results of the signal processor 8.

The memory unit 2 is provided mainly for storing the program data, various types of data used for the program data, and the like. The memory unit 2 is made up of the recording medium 10, an interface circuit 11, and the RAM (Random Access Memory) 12, for instance. The interface circuit 11 is connected to the recording medium 10. The interface circuit 11 and the RAM 12 are connected through the bus 6. The recording medium 10 serves to store the program data of the operating system, the game data made up of the image data, the audio data, various types of program data, and the like. For example, this recording medium 10 is a ROM (Read Only Memory) cassette, an optical disk, a flexible disk, or the like. The program data of the operating system, the game data, and the like are stored in this recording medium 10. Note that a card memory is also included in the category of the recording medium 10 and is mainly used for storing various game parameters at the point of interruption when the game is interrupted. The RAM 12 is used for temporarily storing various types of data read out of the recording medium 10, and for temporarily recording the processing results from the control unit 1. In addition to various types of data, the address data indicating the memory location of various types of data is stored in the RAM 12, and it is configured to be allowed to specify an arbitrary address and read/write data from/to the address.

The image display unit 3 is provided for mainly outputting the image data written to the RAM 12 by the image processor 9, the image data to be read out of the recording medium 10, and the like, as an image. The image display unit 3 is made up of a television monitor 20, an interface circuit 21, and a D/A converter (Digital-to-Analog converter) 22, for instance. The D/A converter 22 is connected to the television monitor 20, and the interface circuit 21 is connected to the D/A converter 22. In addition, the bus 6 is connected to the interface circuit 21. Here, the image data is provided to the D/A converter 22 through the interface circuit 21, and is herein converted into an analog image signal. Then, the analog image signal is outputted to the television monitor 20 as an image.

Here, the image data includes the polygon data, the texture data, and the like, for instance. The polygon data is the coordinate data of apexes forming the polygon. The texture data is used for setting texture with respect to the polygon, and is made up of the texture specifying data and the texture color data. The texture specifying data is the data for associating the polygon and the texture, and the texture color data is the data for specifying the texture color. Here, the polygon address data and the texture address data, both of which indicate the memory location of each type of data, are associated with the polygon data and the texture data, respectively. With the image data of this type, the coordinate conversion and the perspective projection conversion are performed with respect to the polygon data in the three-dimensional space (i.e., the three-dimensional polygon data) indicated with the polygon address data by the signal processor 8, based on the displacement data and the rotational data of the screen itself (i.e., point of sight). Accordingly, the polygon data is converted into the polygon data in the two-dimensional space (i.e., the two-dimensional polygon data). Then, a polygon outline is constituted with a plurality of two-dimensional polygon data, and the texture data specified by the texture address data is written to the internal area of the polygon. Thus, it is possible to express objects made by applying texture to each polygon, that is, various characters.

The audio output unit 4 is provided mainly for outputting the audio data to be read out of the recording medium 10 as the audio. The audio output unit 4 is made up of a speaker 13, an amplifier circuit 14, a D/A converter 15, and an interface circuit 16, for instance. The amplifier circuit 14 is connected to the speaker 13. The D/A converter 15 is connected to the amplifier circuit 14. The interface circuit 16 is connected to the D/A converter 15. In addition, the bus 6 is connected to the interface circuit 16. Here, the audio data is provided to the D/A converter 15 through the interface circuit 16 and is converted into an analog audio signal. The analog audio signal is amplified by the amplifier circuit 14 and is outputted from the speaker 13 as the audio. ADPCM (Adaptive Differential Pulse Code Modulation) data, PCM (Pulse Code Modulation) data, and the like are included in the category of the audio data, for instance. In the case of the ADPCM data, it is possible to output the audio from the speaker 13 with almost the same type of processing method as described above. In the case of the PCM data, it is possible to output the audio from the speaker 13 with almost the same type of processing method as described above by preliminarily converting the PCM data into the ADPCM data in the RAM 12.

The operation input unit 5 is mainly made up of an operation information interface circuit 18 and an interface circuit 19. The controller 25 is connected to the operation information interface circuit 18, and the interface circuit 19 is connected to the operation information interface circuit 18. In addition, the bus 6 is connected to the interface circuit 19.

The controller 25 is an operating device used by a game player for the purpose of inputting a variety of operating commands, and transmits an operating signal corresponding to a game player's operation to the CPU 7. An acceleration sensor 24 is embedded in the controller 25. For example, a piezo resistance sensor, a capacitance sensor, a magnetic sensor, and the like are included in the category of the acceleration sensor 24. When the controller 25 is moved, magnitude of acceleration of the controller 25 is measured and outputted by the acceleration sensor 24 of this type depending on movement of the controller 25. The acceleration sensor 24, which is herein used, is a triaxial acceleration sensor, and magnitude of accelerations in the triaxial directions are measured and outputted by the acceleration sensor 24 depending on movement of the controller 25. In other words, when the controller 25 is moved, magnitudes of accelerations in the triaxial directions from the acceleration sensor 24 are outputted as the acceleration data from the controller 25 to the operation input unit 5. It is possible to cause the control unit 1 to recognize movement of the controller 25 in the three-dimensional space by causing the control unit 1 to recognize and process the acceleration data.

Also, the controller 25 is provided with, for instance, a cross-shaped direction key made up of an up key 17U, a down key 17D, a left key 17L, and a right key 17R. For example, it is possible to move a character, an object, and a cursor on the screen of the television monitor 20 up, down, left, and right by the manipulation of the up key 17U, the down key 17D, the left key 17L, and the right key 17R. When the up key 17U, the down key 17D, the left key 17L, and the right key 17R are respectively manipulated, an operating signal corresponding to each of the keys is outputted from the controller 25 to the operation input unit 5, and a command corresponding to the operating signal is recognized by the control unit 1.

Note that each button and each key provided in the controller 25 are configured to function as ON/OFF switches that become an on-state when pressed from the neutral position by the external pressure and become an off-state by returning to the neutral position when the pressure is released.

The general operations of the home video game device configured as described above will be hereinafter explained. If a power switch (not illustrated in the figure) is turned on and accordingly the game system 1 is powered on, the CPU 7 reads out the image data, the audio data, and the program data from the recording medium 10 based on the operating system stored in the recording medium 10. All or part of the read-out data including the image data, the audio data, and the program data are stored in the RAM 12. Then, the CPU 7 issues commands to the image data and the audio data, both of which are stored in the RAM 12, based on the program data stored in the RAM 12.

In the case of the image data, the signal processor 8 firstly performs the positional computation, the light source computation, and the like for a character in the three-dimensional space based on the command from the CPU 7. Next, the image processor 9 performs a processing of writing the image data to be rendered to the RAM 12 based on the computation results by the signal processor 8. Then, the image data written to the RAM 12 is provided to the D/A converter 15 through the interface circuit 16. Here, the image data is converted into an analog image signal by the D/A converter 15. Then, the image data is provided to the television monitor 20 and is displayed as an image.

In the case of the audio data, the signal processor 8 firstly performs processing to generate and process the audio data based on the command from the CPU 7. Here, processing, such as the pitch conversion, the noise addition, the envelope setting, the level setting, and the reverb addition, is performed for the audio data. Next, the audio data is outputted from the signal processor 8 and is provided to the D/A converter 15 through the interface circuit 16. Here, the audio data is converted into an analog audio signal. Then, the audio data is outputted as the audio from the speaker 13 through the amplifier circuit 14.

### Summary of a Variety of Processing in Game Device

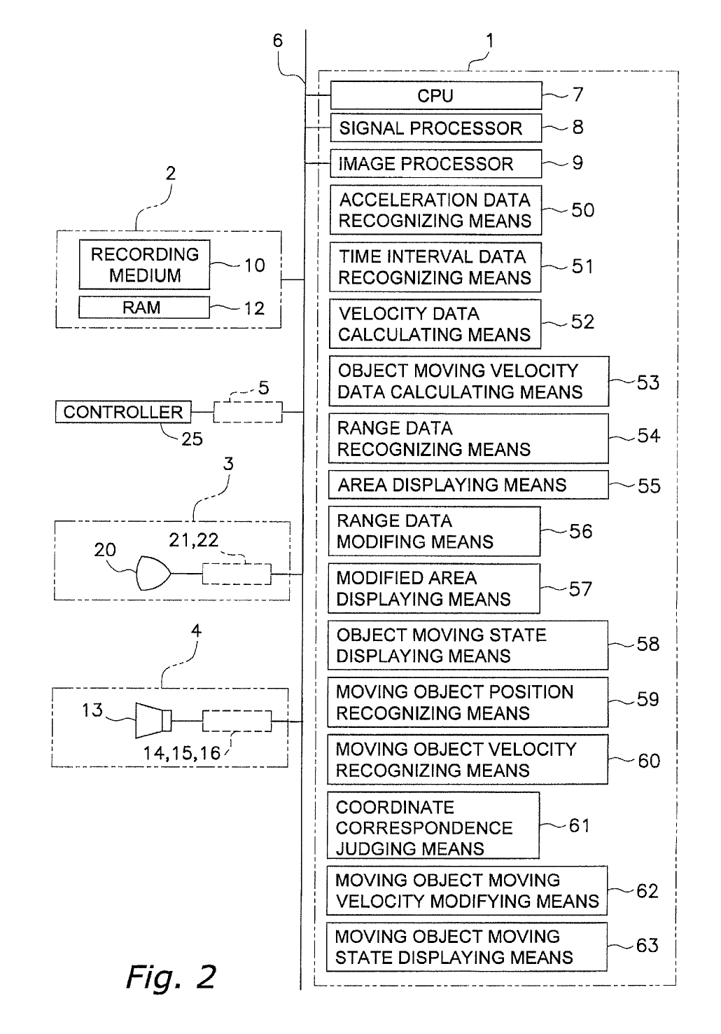

A game executed in a present game console 1 is a baseball game, for instance. The present game console 1 is configured to be capable of executing a video game in which an object, an area changing in conjunction with movement of the object, and a moving object are displayed on the television monitor 20 of the image display unit 3 and the object is caused to move in conjunction with movement of the controller 25 in which the acceleration sensor 24 is embedded based on the acceleration data detected by the acceleration sensor 24 and accordingly the area is caused to change. FIG. 2 is a functional block diagram for illustrating functions that play major roles in the present invention.

Acceleration data recognizing means 50 has a function of causing the control unit 1 to recognize the acceleration data to be consecutively inputted into the operation input unit 4. In the acceleration data recognizing means 50, the acceleration data to be consecutively inputted into the operation input unit 5 is recognized by the control unit 1. Specifically, the acceleration data recognizing means 50 causes the control unit 1 to judge whether or not a value of the acceleration data recognized by the control unit 1 is greater than or equal to a predetermined value. If it is judged by the control unit 1 that the value of the acceleration data recognized by the control unit 1 is greater than or equal to the predetermined value, the acceleration data recognizing means 50 causes the control unit 1 to recognize the acceleration data.

Time duration data recognizing means 51 has a function of causing the control unit 1 to recognize time duration of the acceleration data to be consecutively inputted into the operation input unit 5 as the time duration data. In the time duration data recognizing means 51, the time duration of the acceleration data to be consecutively inputted into the operation input unit 5 is recognized by the control unit 1 as the time duration data.

Velocity data calculating means 52 has a function of causing the control unit 1 to calculate the velocity magnitude (speed) data of the controller 25 based on the acceleration data and the time duration data, both of which are recognized by the control unit 1. In the velocity data calculating means 52, the velocity magnitude data of the controller 25 is calculated by the control unit 1 based on the acceleration data and the time duration data, both of which are recognized by the control unit 1. Specifically, the velocity magnitude data of the controller 25 is calculated by the control unit 1 when the velocity data calculating means 52 causes the control unit 1 to perform the integral calculation for the acceleration data recognized by the control unit 1 with the time duration data. Also, the position data of the controller 25 is calculated by the control unit 1 when the means causes the control unit 1 to perform the integral calculation for the velocity magnitude data with the time duration data.

Object moving velocity data calculating means 53 has a function of causing the control unit 1 to calculate the velocity magnitude data of the object based on the velocity magnitude data of the controller 25. In the object moving velocity data calculating means 53, the velocity magnitude data of the object is calculated by the control unit 1 based on the velocity magnitude data of the controller 25. Specifically, in the object moving velocity data calculating means 53, the velocity data of the object is calculated by the control unit 1 by multiplying the velocity magnitude data of the controller 25 by the modification coefficient for the image display. Also, in the means, the calculation of converting the position data of the controller 25 into the position data of the television monitor 20 of the image display unit 3 is performed by the control unit 1.

Range data recognizing means 54 has a function of causing the control unit 1 to recognize the range data of the area changing in conjunction with movement of the object. In the range data recognizing means 54, the range data of the area changing in conjunction with movement of the object is recognized by the control unit 1. The range data of the area is made up of, for instance, the boundary coordinate data indicating a boundary of the range of the area, the reference point coordinate data indicating a reference point of the range of the area, and the within-area coordinate data within the range of the area. Note that the initial range data of the area as the initial condition is preliminarily set in the game program, and the initial range data of the area is recognized by the control unit 1.

Area displaying means 55 has a function of displaying an area set by the range data of the area on the television monitor 20 of the image display unit 3 with the image data. In the area displaying means 55, the area set by the range data of the area is displayed on the television monitor 20 of the image display unit 3 with the image data. Specifically, in the area displaying means 55, the area set by the range data of the area is displayed on the television monitor 20 of the image display unit 3 with the image data if the range data of the area has been in the initial state and when the range data of the area was not modified. On the other hand, when the range data of the area was modified, in modification area displaying means 57 to be described, the area set by the modified range data of the area is displayed on the television monitor 20 of the image display unit 3 with the image data.

Range data modifying means 56 has a function of causing the control unit 1 to perform the calculation of modifying the range data of the area into the range data of changing the range of the area depending on the velocity magnitude of the object. In the range data modifying means 56, the calculation of modifying the range data of the area into the range data of changing the range of the area depending on the velocity magnitude of the object is performed by the control unit 1. Also, the range data modifying means 56 has a function of causing the control unit 1 to judge whether or not the velocity set by the velocity magnitude data of the object is greater than the reference velocity set by the reference velocity magnitude data of the object.

In the range data modifying means 56, it is judged by the control unit 1 whether or not the velocity set by the velocity magnitude data of the object is greater than the reference velocity set by the reference velocity magnitude data of the object. Then, if the velocity set by the velocity magnitude data of the object is greater than the reference velocity set by the reference velocity magnitude data of the object, the calculation of modifying the range data of the area into the range data of reducing the range of the area depending on the velocity magnitude of the object is performed by the control unit 1. On the other hand, if the velocity set by the velocity magnitude data of the object is less than the reference velocity set by the reference velocity magnitude data of the object, the calculation of modifying the range data of the area into the range data of expanding the range of the area depending on the velocity magnitude of the object is performed by the control unit 1. Note that the calculation of modifying the range data of the area is performed by the control unit 1 depending on ratio of the velocity of the object with respect to the reference velocity of the object.

Modified area displaying means 57 has a function of displaying the area set by the modified range data of the area on the television monitor 20 of the image display unit 3 with the image data. In the modified area displaying means 57, the area set by the modified range data of the area is displayed on the television monitor 20 of the image display unit 3 with the image data. Specifically, the area is displayed on the television monitor 20 of the image display unit 3 with the image data that is obtained when the control unit 1 is caused to perform an expansion processing or a reduction processing for the image data corresponding to the range data of the area based on the modified range data of the area.

Object moving state displaying means 58 has a function of consecutively displaying a state of the object moving at the velocity set by the velocity magnitude data of the object on the television monitor 20 of the image display unit 3 with the image data corresponding to the object. In the object moving state displaying means 58, a state of the object moving at the velocity set by the velocity magnitude data of the object is consecutively displayed on the television monitor 20 of the image display unit 3 with the image data corresponding to the object.

Moving object position recognizing means 59 has a function of causing the control unit 1 to recognize the position data of the moving object (second object) that is in motion. In the moving object position recognizing means 59, the position data of the moving object that is in motion is recognized by the control unit 1. The position data of the moving object is made up of the reference coordinate data indicating a reference point (center point) of the moving object and within-display range coordinate data within the display range of the moving object.

Moving object velocity recognizing means 60 has a function of causing the control unit 1 to recognize the velocity magnitude data of the moving object that is in motion. In the moving object velocity recognizing means 60, the velocity magnitude data of the moving object that is in motion is recognized by the control unit 1. Note that the velocity magnitude data of the moving object as the initial condition is calculated by the control unit 1 before the moving object starts moving or when the moving object moves.

Coordinate correspondence judging means 61 has a function of causing the control unit 1 to judge whether or not the coordinate within the range of the area set by the modified range data of the area corresponds to at least one of the coordinates within the area of the moving object set by the position data of the moving object. In the coordinate correspondence judging means 61, it is judged by the control unit 1 whether or not the coordinate within the range of the area set by the modified range data of the area corresponds to at least one of the coordinates within the area of the moving object set by the position data of the moving object. Specifically, in the coordinate correspondence judging means 61, it is judged by the control unit 1 whether or not the coordinate set by the within-area coordinate data of the modified range data of the area corresponds to at least one of the within-display range coordinate data of the moving object set by the within-range coordinate data of the position data of the moving object.

Moving object moving velocity modifying means 62 has a function of causing the control unit 1 to perform the calculation of modifying the velocity magnitude data of the moving object depending on distance between the reference point of the area set by the modified range data of the area and the reference point of the moving object set by the position data of the moving object when it is judged by the control unit 1 that the coordinate within the range of the area set by the modified range data of the area corresponds to at least one of the coordinates within the area of the moving object set by the position data of the moving object. Also, the moving object moving velocity modifying means 62 has a function of causing the control unit 1 to perform the calculation of modifying the velocity magnitude data of the moving object depending on the velocity magnitude of the object when it is judged by the control unit 1 that the coordinate within the range of the area set by the range data of the area corresponds to at least one of the coordinates within the area of the moving object set by the position data of the moving object.

In the moving object moving velocity modifying means 62, the calculation of modifying the velocity magnitude data of the moving object is performed by the control unit 1 depending on distance between the reference point of the area set by the modified range data of the area and the reference point of the moving object set by the position data of the moving object and the velocity magnitude of the object, when it is judged by the control unit 1 that the coordinate within the range of the area set by the modified range data of the area corresponds to at least one of the coordinates within the area of the moving object set by the position data of the moving object.

Specifically, the calculation of modifying the velocity magnitude data of the moving object is performed by the control unit 1 depending on distance between the reference point of the area set by the modified range data of the area and the reference point of the moving object set by the position data of the moving object and the velocity magnitude set by the velocity magnitude data of the object, when it is judged by the control unit 1 that the coordinate set by the within-area coordinate data of the modified range data of the area corresponds to at least one of the within-display range coordinate data of the moving object set by the within-range coordinate data of the position data of the moving object.

Moving object moving state displaying means 63 has a function of consecutively displaying a state of the moving object moving at the velocity set by the modified velocity magnitude data of the moving object on the television monitor 20 of the image display unit 3 with the image data corresponding to the moving object. In the moving object moving state displaying means 63, a state of the moving object moving at the velocity set by the modified velocity magnitude data of the moving object is consecutively displayed on the television monitor 20 of the image display unit 3 with the image data corresponding to the moving object. The state is realized by displaying the image data corresponding to the moving object on the television monitor 20 while the coordinate position of the reference point set by the reference coordinate data of the moving object, which changes in accordance with movement of the moving object, is set as the reference.

### Summary of Cooperative System of Bat and Contact Hitting Cursor in Baseball Game and Flow of a Variety of Processing

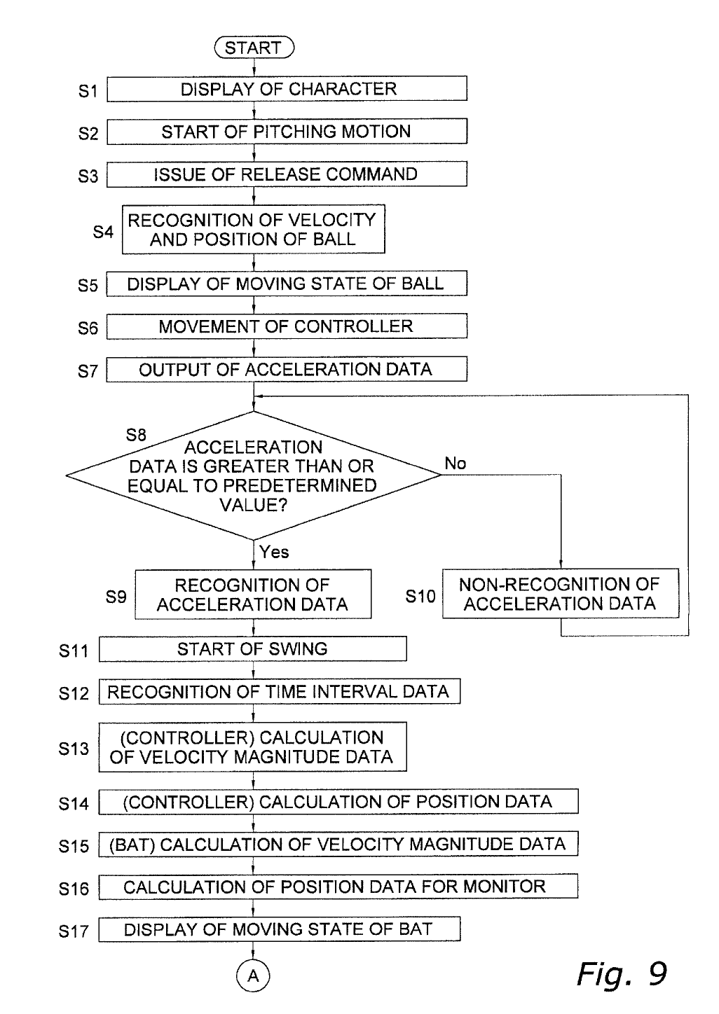

A corporative system of a bat and a contact hitting cursor in the baseball game will be hereinafter explained. In addition, flow of the cooperative system of the bat and the contact hitting cursor illustrated in FIG. 9 will be simultaneously explained.

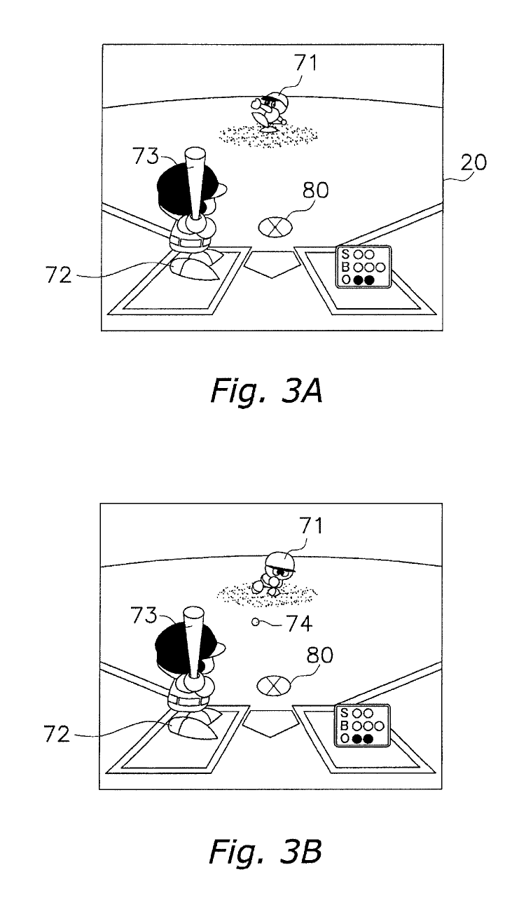

As illustrated in FIG. 3, when a game player operates a batter character in the present baseball game, a pitcher character 71, a batter character 72 holding a bat, a contact hitting cursor area 80 in the reference state are displayed on the television monitor 20 (S1). Here, the initial range data for setting the contact hitting cursor area 80 in the reference state is preliminarily set in the game program, and the initial range data of the contact hitting cursor area 80 is read out of the memory unit 2 and is recognized by the control unit 1.

Here, when a signal, which is issued by the controller 25 when a pitching starting corresponding button (not illustrated in the figure) of the controller 25 is pressed, is received by the control unit 1, a command for causing the pitcher character 71 to start pitching is issued by the control unit 1 based on the game program. Accordingly, a state of the pitcher character 71 performing a pitching motion is displayed on the television monitor 20 by causing the image data (e.g., polygon data) corresponding to the pitcher character 72 to consecutively move (S2). Then, when the predetermined pitching motion of the pitcher character 71 is completed, a command for causing the pitcher character 71 to release a ball is recognized by the control unit 1 (S3).

Accordingly, the control unit 1 starts recognition of velocity magnitude data VB and the position data of the ball released by the pitcher character 71 (S4). Here, the position data of the ball character 74 is made up of the reference coordinate data indicating the center point (reference point) Bm of the ball and the within-display range coordinate data within the display range of the ball. Then, a state that the ball character 74 released by the pitcher character 71 moves from the pitcher character 71 to the batter character 72 is displayed on the television monitor 20 based on the reference coordinate data indicating the center point Bm of the ball (S5). The state is realized by causing the image data corresponding to the ball character 74 to move from the pitcher character 71 to the batter character 72, and movement of the ball character 74 is herein controlled by the control unit 1.

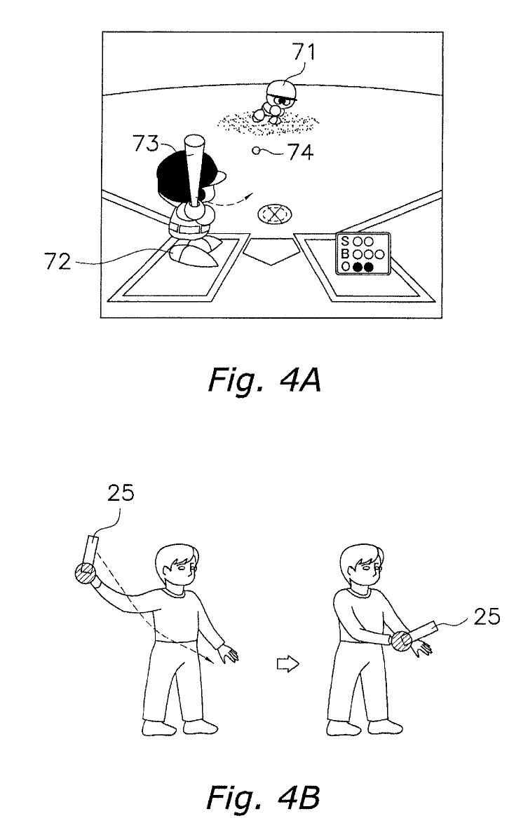

As illustrated in FIG. 4, if a game player moves the controller 25 (e.g., if a game player swings his/her arm together with the controller 25 while holding the controller 25: S6) while a state that the ball character 74 released by the pitcher character 71 moves from the pitcher character 71 to the batter character 72 is displayed on the television monitor 20, acceleration data G detected by the acceleration sensor 24 embedded in the controller 25 is consecutively outputted from the controller 25 to the operation input unit 5 and is inputted into the operation input unit 5 (S7).

Accordingly, it is judged by the controller unit 1 whether or not the absolute value of the acceleration data G inputted into the operation input unit 5 is greater than or equal to a predetermined value (S8). If it is judged by the control unit 1 that the absolute value of the acceleration data G is greater than or equal to the predetermined value (Yes in S8), the acceleration data G is recognized by the control unit 1 (S9). Accordingly, a state of the bat moving with the batter character 72, that is, a state of the batter character 72 swinging the bat, is displayed on the television monitor 20 (S10). Here, if it is judged by the control unit 1 that the absolute value of the acceleration data G inputted into the operation input unit 5 is less than a predetermined value (No in S8), the acceleration data G is not recognized by the control unit 1 (S1). In other words, the bat does not move with the batter character 72 (the batter character 72 does not swing the bat).

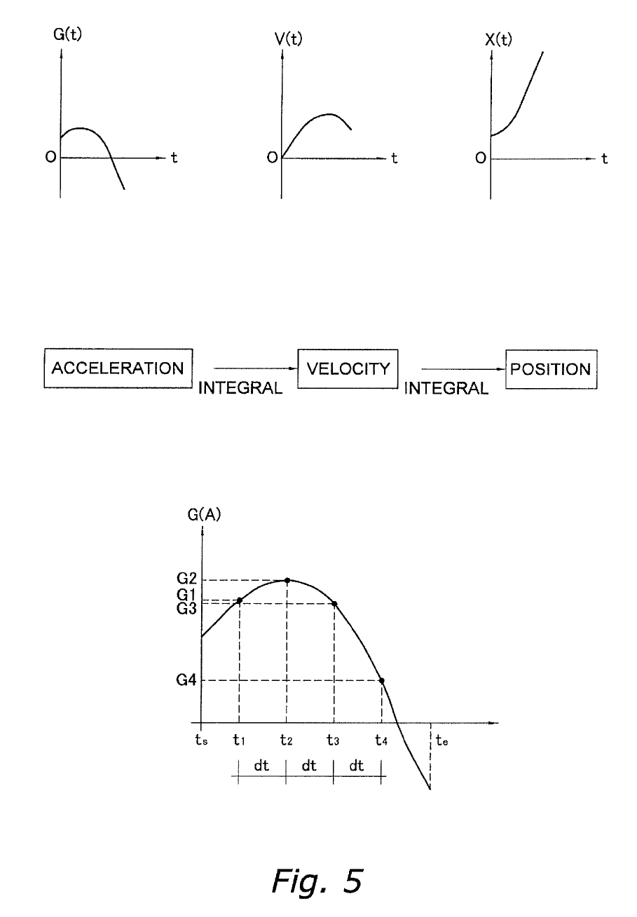

When the acceleration data G is sequentially recognized by the control unit 1, time duration of the acceleration data G consecutively inputted into the operation input unit 5 is recognized by the control unit 1 as the time duration data dt (S12). Accordingly, as illustrated in FIG. 5, the integral calculation is performed by the control unit 1 for the acceleration data G recognized by the control unit 1 with the time duration data dt, and velocity magnitude data V of the controller 25 is calculated by the control unit 1 (S13). Also, the integral calculation is performed by the control unit 1 for the velocity magnitude data V of the controller 25 with the time duration data dt, and position data X of the controller 25 is calculated by the control unit 1 (S14).

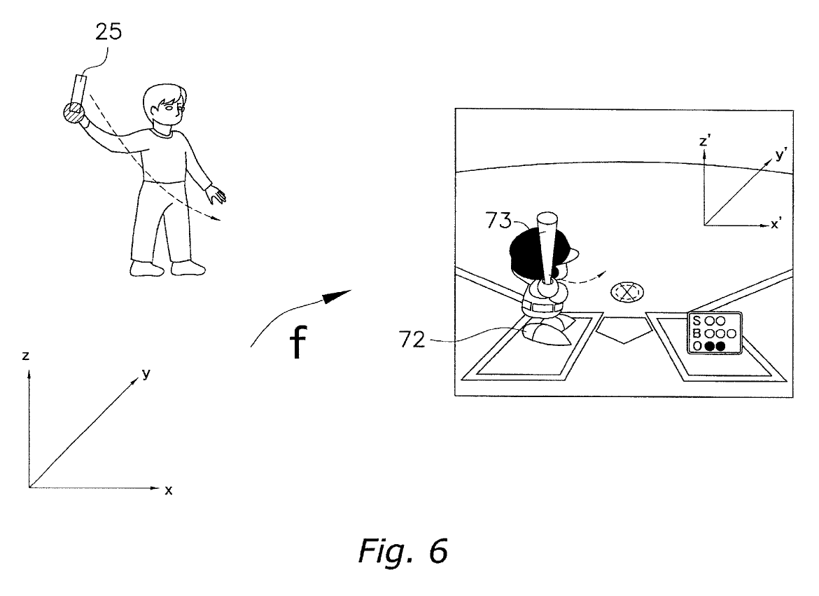

Accordingly, the calculation of multiplying the velocity magnitude data V of the controller 25 by the modification coefficient α for the image display is performed by the control unit 1, and velocity magnitude data VBT (α·V) of the bat is calculated by the control unit 1 (S15). Then, the calculation of converting the position data X of the controller 25 into the position data X′ of the television monitor 20 of the image display unit 3 is performed by the control unit 1 (See FIG. 6: S16). Accordingly, a state of the bat moving at the velocity set by the velocity magnitude data VBT of the bat in the position set by the position data X′, that is, a moving state of the bat moving with the batter character 72 (bat swing state), is consecutively displayed on the television monitor 20 by causing the image data (e.g., polygon data) corresponding to the bat to move on the television monitor 20 of the image display unit 3 (S17).

The state is realized by causing the image data (e.g., polygon data) of the batter character 72 and the bat character 73 to consecutively move on the television monitor 20 with the time duration set by the rendering time duration data so that the bat character 73 moves at the velocity set by the velocity magnitude data VBT of the bat. The rendering time duration data is regulated by the control unit 1 depending on the velocity magnitude data. For example, the reference moving velocity magnitude and the reference rendering time duration (e.g., 0.02 seconds) of the bat on the game screen are set in the game program. Under the condition that this reference state is set as the reference, if the moving velocity of the bat is faster than the reference moving velocity, that is, if the moving velocity magnitude of the bat is greater than the reference moving velocity magnitude, the polygon data is displayed on the television monitor 20 at the time duration less than the duration of 0.02 seconds. On the other hand, if the moving velocity of the bat is slower than the reference moving velocity, that is, if the moving velocity magnitude of the bat is less than the reference moving velocity magnitude, the polygon data is displayed on the television monitor 20 at the time duration greater than the time duration of 0.02 seconds. Here, the rendering time duration is calculated by multiplying the reference time duration by rate (ratio) of the calculated velocity magnitude of the bat with respect to the reference moving velocity.

Subsequently, it is judged by the control unit 1 whether or not the velocity set by the velocity magnitude data of the bat is greater than the reference velocity set by the reference velocity magnitude data of the bat (S18). Then, if it is judged by the control unit 1 that the velocity set by the velocity magnitude data of the bat is greater than the reference velocity set by the reference velocity magnitude data of the bat (Yes in S18), the calculation of modifying the range data of the contact hitting cursor area 80 into the range data of reducing the range of the contact hitting cursor area 80 depending on the velocity magnitude of the bat is performed by the control unit 1 (S19). Then, the modified range data of the contact hitting cursor area 80 is recognized by the control unit 1. On the other hand, if it is judged by the control unit 1 that the velocity set by the velocity magnitude data of the bat is less than the reference velocity set by the reference velocity magnitude data of the bat (No in S18), the calculation of modifying the range data of the contact hitting cursor area 80 into the range data of expanding the range of the contact hitting cursor area 80 depending on the velocity magnitude of the bat is performed by the control unit 1 (S20). Then, the modified range data of the contact hitting cursor area 80 is recognized by the control unit 1. Here, the range data of the contact hitting cursor area 80 is made up of the boundary coordinate data indicating a boundary 80a of the contact hitting cursor area 80, the reference point coordinate data indicating a reference point 80b of the contact hitting cursor area 80, and the within-area coordinate data of a contact hitting area inside part 80c. Accordingly, the contact hitting cursor area 80 set by the modified range data of the contact hitting cursor area 80 is displayed on the television monitor 20 of the image display unit 3 with the image data (S21). As described above, it is possible to expand or reduce the contact hitting cursor area 80 depending on the velocity magnitude of the bat to be generated when the controller 25 is moved.

Then, it is judged by the control unit 1 whether or not the coordinate set by the within-area coordinate data of the modified range data of the contact hitting cursor area 80 corresponds to at least one of the coordinates set by the within-range coordinate data of the position data of the ball (S22). Specifically, it is judged by the control unit 1 whether or not the ball is hit with the bat. Then, if it is judged by the control unit 1 that the coordinate set by the within-area coordinate data of the modified range data of the contact hitting cursor area 80 corresponds to at least one of the coordinates set by the within-range coordinate data of the position data of the ball (Yes in S22), the calculation of modifying velocity magnitude data VB of the ball is performed by the control unit 1 depending on distance between the reference point of the contact hitting cursor area 80 set by the modified range data of the contact hitting cursor area 80 and the reference point of the ball set by the position data of the ball, and the velocity magnitude set by the velocity magnitude data of the bat (S23). On the other hand, if it is judged by the control unit 1 that the coordinate set by the within-area coordinate data of the modified range data of the contact hitting cursor area 80 does not correspond to at least one of the coordinates set by the within-range coordinate data of the position data of the ball (No in S22), the calculation of modifying the velocity magnitude data VB of the ball is not performed by the control unit 1 (S24).

Specifically, with the modification calculation, when the ball is hit with the bat while the contact hitting cursor area 80 is in the reference state, the velocity of the ball hit back with the bat becomes greater as the velocity magnitude of the bat becomes greater, and it becomes less as the velocity magnitude of the bat becomes less. Also, when the ball is hit with the bat while the contact hitting cursor area 80 is in the reduction state, the velocity of the ball hit back with the bat becomes greater as the velocity magnitude of the bat becomes greater, and it becomes less as the velocity magnitude of the bat becomes less. Here, the velocity of the ball hit back with the bat becomes greater than that under the condition that the contact hitting cursor area 80 is in the reference state. Furthermore, when the ball is hit with the bat while the contact hitting cursor area 80 is in the expansion state, the velocity of the ball hit back with the bat becomes greater as the velocity magnitude of the bat becomes greater, and it becomes less as the velocity magnitude of the bat becomes less. Here, the velocity of the ball hit back with the bat is less than that under the condition that the contact hitting cursor area 80 is in the reference state.

Then, a state of the ball moving at the velocity set by the modified velocity magnitude data of the ball is consecutively displayed on the television monitor 20 of the image display unit 3 with the image data corresponding to the ball (S25). The state is realized by consecutively displaying the image data corresponding to the ball on the television monitor 20 while the coordinate position of the reference point set by the reference coordinate data of the ball is set as the reference.

### Contents of Processing in Each Means of Cooperative System of Bat and Contact Hitting Cursor and Supplementary Explanation Thereof.

velocity data calculating means

When the acceleration data G made up of magnitudes of the accelerations in the triaxial directions is recognized by the control unit 1 and then time duration of the acceleration data G (gx, gy, gz, t) consecutively inputted into the operation input unit 5 from the controller 25 is recognized by the control unit 1 as the time duration data dt, as illustrated in FIG. 5, the integral calculation is performed by the control unit 1 for the acceleration data G consecutively inputted into the operation input unit 5 from the controller 25 with the time duration data dt, and the velocity magnitude data V (vx, vy, vz, t) of the controller 25 in the triaxial directions is calculated by the control unit 1. For example, when acceleration data G1 (gx1, gy1, gz1, t1) is firstly recognized by the control unit 1 at time t1 and subsequently acceleration data G2 (gx2, gy2, gz2, t2) is recognized by the control unit 1 at time t2, velocity magnitude data V1 (vx1, vy1, vz1, t1) of the controller 25 is calculated by the control unit 1 by causing the control unit 1 to perform the calculation of “∫[G2 (gx2, gy2, gz2, t2)−G1 (gx1, gy1, gz1, t1)]·dt” between the time t2 and the time t1. In a similar way to the above, when acceleration data G3 (gx3, gy3, gz3, t3) is recognized by the control unit 1 at time t3 succeeding the time t2, velocity magnitude data V2 (vx2, vy2, vz2, t2) of the controller 25 is calculated by the control unit 1 by causing the control unit 1 to perform the calculation of “J [G3 (gx3, gy3, gz3, t3)−G2 (gx2, gy2, gz2, t2)]·dt” between the time t3 and the time t2. Also, when acceleration data G4 (gx4, gy4, gz4, t4) is recognized by the control unit 1 at time t4 succeeding the time t3, velocity magnitude data V3 (vx3, vy3, vz3, t3) of the controller 25 is calculated by the control unit 1 by causing the control unit 1 to perform the calculation of “J [G4 (gx4, gy4, gz4, t4)−G3 (gx3, gy3, gz3, t3)]·dt” between the time t4 and the time t3.

When the integral calculation is further performed by the control unit 1 for thus calculated velocity magnitude data V of the controller 25 with the time duration data dt, the position data X of the controller 25 is calculated by the control unit 1. For example, position data X1 (x1, y1, z1, t1) of the controller 25 is calculated by the control unit 1 by causing the control unit 1 to perform the calculation of “∫[V2 (vx2, vy2, vz2, t2)−V1 (vx1, vy1, vz1, t1)]·dt” between the time t2 and the time t1. In a similar way to this, position data X2 (x2, y2, z2, t2) of the controller 25 is calculated by the control unit 1 by causing the control unit 1 to perform the calculation of “∫[V3 (vx3, vy3, vz3, t3)−V2 (vx2, vy2, vz2, t2)]·dt” between the time t3 and the time t2.

It is possible to calculate the velocity magnitude data and the position data of the controller 25 in each time based on the acceleration data G of the controller 25 by causing the control unit 1 to perform the above series of calculations when the acceleration data G of the controller 25 is recognized by the control unit 1.

Note that when the velocity magnitude data V and the position data X of the controller 25 are calculated, time ts at which the acceleration data G of the controller 25 is recognized by the control unit for the first time is set to be the calculation starting time. Also, time te at which it is judged by the control unit 1 that the coordinate set by the within-area coordinate data of the modified range data of the contact hitting cursor area 80 corresponds to at least one of the within-display range coordinate data of the ball that is set by the within-range coordinate data of the position data of the ball, that is, time te at which the ball is hit with the bat, is set to be the calculation ending time.

### Object Moving Velocity Data Calculating Means

The velocity magnitude data VBT of the bat is calculated by causing the control unit 1 to perform the calculation of multiplying the velocity magnitude data V of the controller 25 by the modification coefficient α for the image display. This is the processing performed for modifying the velocity magnitude data calculated based on the acceleration data G of the actually moved controller 25 into the moving velocity of the bat used in the game. For example, the velocity magnitude data VBT of the bat is calculated by the control unit 1 by causing the control unit 1 to perform the calculation of multiplying the above calculated velocity magnitude data V1 and V2 of the controller 25 by the modification coefficient α (constant) or the modification coefficient depending on the velocity magnitude data V1 and V2 of the controller 25, that is, the modification coefficient α (V) in which the velocity magnitude data V of the controller 25 is set to be a variable.

### Object Moving State Displaying Means

As illustrated in FIG. 6, the above calculated position data X1 and X2 of the controller 25 are converted into position data X′1 and X′2 for the television monitor 20. The position data X1 and X2 of the controller 25 are coordinates in the three-dimensional real space (space in which a game player swings his/her arm together with the controller 25). Therefore, the calculation of converting the position data X1 and X2 of the controller 25 into the position data X′1 and X′2 for the television monitor 20 in the three-dimensional game space is herein performed by the control unit 1. The conversion is performed by causing the control unit 1 to perform the mapping from the three-dimensional real space to the three-dimensional game space. For example, the conversion is performed by causing the control unit 1 to perform the calculation of “X′(x′, y′, z′)=f·X (x, y, z)” with the map function f preliminarily determined in the game program. A state of the bat character 73 moving at the velocity set by the velocity magnitude data of the bat in the position set by the position data X′ 1 and X′2 of the bat in the three-dimensional game space is displayed on the television monitor 20.

### Range Data Modifying Means and Modified Area Displaying Means

When the velocity set by the velocity magnitude data VBT of the bat is greater than the reference velocity set by the reference velocity magnitude data VBT0 of the bat, the calculation of modifying the range data of the contact hitting cursor area 80 into the range data of reducing the range of the contact hitting cursor area 80 depending on the velocity magnitude of the bat is performed by the control unit 1. On the other hand, when the velocity set by the velocity magnitude data VBT of the bat is less than the reference velocity set by the reference velocity magnitude data VBT0 of the bat, the calculation of modifying the range data of the contact hitting cursor area 80 into the range data of expanding the range of the contact hitting cursor area 80 depending on the velocity magnitude of the bat is performed by the control unit 1.

The above described calculation of modifying the range data of the contact hitting cursor area 80 depending on the velocity magnitude of the bat for the purpose of expanding or reducing the range of the contact hitting cursor area 80 is performed by the control unit 1 as follows.

First, the correction coefficient β (=VBT′/VBT0′) of the velocity magnitude VBT′ of the bat, which is set by the velocity magnitude data VBT of the bat recognized by the control unit 1, with respect to the reference velocity VBT0′ of the bat, which is set by the reference velocity data VBT0 of the bat recognized by the control unit 1, is calculated by the control unit 1. The range data of the contact hitting cursor area 80 is modified by multiplying the range data of the contact hitting cursor area 80 by the correction coefficient β. The range data of the contact hitting cursor area 80 is made up of the contact hitting cursor boundary coordinate data Xm (x″, z″, t), the contact hitting cursor reference point coordinate data Xk (x″, z″, t), and the within-contact hitting cursor area coordinate data Xh (x″, z″, t). Here, the contact hitting cursor reference point coordinate data Xk (x″, z″, t) is set to be Xk (0, 0, t), and the contact hitting cursor boundary coordinate data Xm (x″, z″, t) and the within-contact hitting cursor area coordinate data Xh (x″, z″, t) in the relative coordinate system with the origin of the contact hitting cursor reference coordinate data Xk (0, 0, t) are recognized by the control unit 1.

Next, the contact hitting cursor boundary coordinate data Xm (x″, z″, t) of the range data of the contact hitting cursor area 80 is modified by causing the control unit 1 to perform the calculation of multiplying the contact hitting cursor boundary coordinate data Xm (x″, z″, t) by the correction coefficient β while the reference point Am set by the contact hitting cursor reference point coordinate data Xk (x″, z″, t) is set to be the origin.

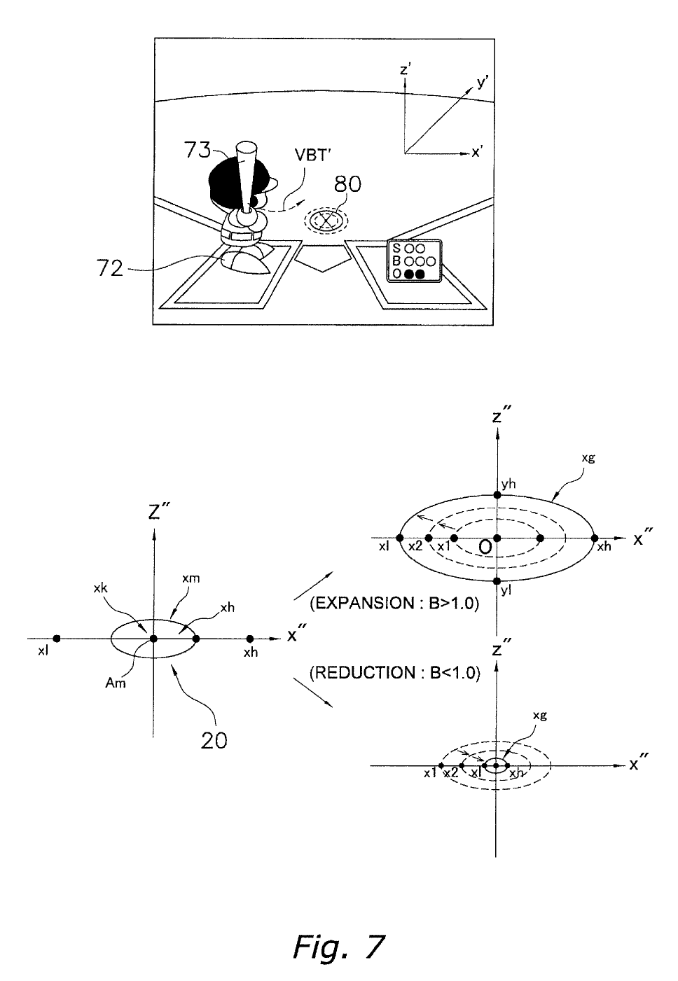

In the modification of expanding the contact hitting cursor area, the modified contact hitting cursor boundary coordinate is modified by the control unit 1 so as not to be less than the minimum value of the contact hitting cursor boundary coordinate and so as not to be greater than the maximum value of the contact hitting cursor boundary coordinate. For example, as illustrated in FIG. 7, if calculation such as “Xm2 (x2, 0)=β·Xm1 (x1, 0)” is performed by the control unit 1 when the minimum value of the x coordinate of the contact hitting cursor boundary coordinate is x1 and the maximum value of the x coordinate is xh, the x coordinate of the Xm2 (x2, 0) is regulated within the range of x1≦x2≦xh. For example, if x2 (=β−x1) is less than the minimum value x1, x2 is corrected to be the minimum value x1 by the control unit 1. Accordingly, the contact hitting cursor area 80 is prevented from being expanded to be greater than or equal to a predetermined size. Also, when x2 (=β·x1) is greater than the maximum value xh, x2 is corrected to be the maximum value xh by the control unit 1. Also, in the modification of reducing the contact hitting cursor area, the maximum value and the minimum value are set in a similar way to the modification of expanding the contact hitting cursor area. Thus, the contact hitting cursor area 80 is prevented from being reduced to be less than or equal to a predetermined size. Note that an explanation for the coordinate x under the condition that the coordinate z is set to be zero is performed for making explanation easier. However, the minimum value and the maximum value are set in the two-dimensional space, and the contact hitting cursor area 80 is expanded or reduced so as to be located within or outside the area set by the minimum value and the maximum value. Here, the limitation value data Xg (xg, yg) that sets the minimum value and the maximum value is set in the game program, and is recognized by the control unit 1 when the game program is loaded.

As described above, when the contact hitting cursor boundary coordinate data Xm (x″, z″, t) of the range data of the contact hitting cursor area 80 is modified, an expansion processing or a reduction processing of the image data of the contact hitting cursor area 80 is performed by the control unit 1 so that the image data of the contact hitting cursor area 80 is located in the interior of the contact hitting cursor boundary set by the contact hitting cursor boundary coordinate data Xm (x″, z″, t). Specifically, the contact hitting cursor area 80 is expanded or reduced and is displayed on the television monitor 20 by causing the control unit 1 to perform a processing for expanding or reducing the pixel data forming the image data of the contact hitting cursor area 80 in the x and z axial directions.

### Coordinate Correspondence Judging Means and Moving Object Moving Velocity Modifying Means

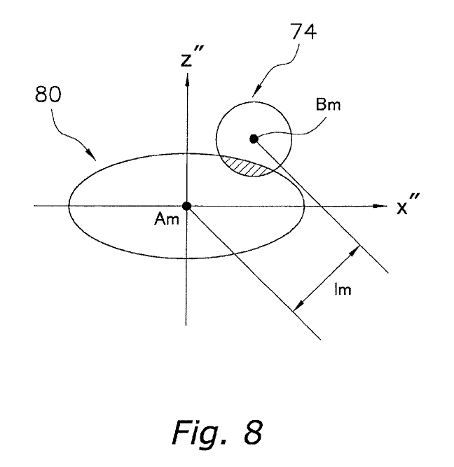

The modified range data of the contact hitting cursor area 80 and the position data of the ball have been recognized by the control unit 1. Then, as illustrated in FIG. 8, it is judged by the control unit 1 whether or not a coordinate within the contact hitting cursor area set by the modified within-area coordinate data Xh of the contact hitting cursor area 80 corresponds to at least one of the coordinates within the ball display area set by the within-display range coordinate data of the position data of the ball. Specifically, it is judged by the control unit 1 whether or not a portion that the contact hitting cursor area 80 and the ball display area overlap with each other is generated, in other words, whether or not the ball is hit with the bat. Then, if it is judged by the control unit 1 that a coordinate within the contact hitting cursor area set by the modified within-area coordinate data Xh of the contact hitting cursor area 80 corresponds to at least one of the coordinates within the ball display area set by the within-display range coordinate data of the position data of the ball, as illustrated in FIG. 8, between-reference points distance lm between the reference point of the contact hitting cursor area 80 set by the modified range data Xh of the contact hitting cursor area 80 and the reference point Bm of the ball set by the position data of the ball is calculated by the control unit 1. Then, the modification coefficient γ corresponding to the between-reference points distance lm and the velocity magnitude VBT′ of the bat is selected by the control unit 1 based on the correspondence table. The velocity magnitude data of the ball hit back with the bat is calculated by the control unit 1 by multiplying the velocity magnitude data VB by the modification coefficient γ. Note that the modification coefficient γ, which is set based on the correspondence table, is configured to be greater as the between-reference points distance lm becomes less and the velocity magnitude VBT′ of the bat becomes greater, and is configured to be less as the between-reference points distance lm becomes greater and the velocity magnitude VBT′ of the bat becomes less.

When meaning of the correspondence table is specifically explained, a condition that the between-reference points distance lm is zero means that the bat makes solid contact with the ball. Then, as the between-reference points distance lm becomes larger than zero, the bat is configured to make less solid contact with the ball. Accordingly, the correspondence table is configured so that the modification coefficient γ corresponding to the between-reference points distance lm becomes larger as the between-reference points distance lm becomes greater. Also, as the velocity magnitude VBT′ of the bat becomes greater, the ball is capable of being hit with the bat while the bat is powerfully swung. Accordingly, the corresponding table is configured so that the modification coefficient Y corresponding to the velocity magnitude VBT′ of the bat becomes greater as the velocity magnitude VBT′ of the bat becomes greater.

### Other Embodiments

(a) In the above described embodiment, a case is exemplified that the home video game device is used as an example of a computer to which the game program is allowed to be applied. However, the game device is not limited to the above described embodiment. The present invention may be applied to a game device for which a monitor is separately provided, a monitor-integrated game device, a personal computer or a workstation that functions as a game device when a game program is executed therein, and the like, as well.

(b) A program for executing the above described game and a computer-readable recording medium in which the program is recorded are also included in the present invention. For example, a computer-readable flexible disk, a semiconductor memory, a CD-ROM, a DVD, a MO, a ROM cassette, and the like may be suggested as the recording medium other than the cartridge.

(c) In the above described embodiment, an example is described that the velocity magnitude data of a ball hit back with a bat is modified by the control unit 1 depending on the between-reference points distance lm and the velocity magnitude VBT′ of the bat when an overlapped portion between the contact hitting cursor area 80 and the ball display area is generated. However, the velocity magnitude data of the ball hit back with the bat may be configured to be modified only depending on the between-reference points distance lm. For example, when a correspondence table indicating relation between the between-reference points distance lm and the modification coefficient γ is prepared, the modification coefficient γ corresponding to the between-reference points distance lm is selected by the control unit 1 in the correspondence table. The velocity magnitude data of the ball hit back with the bat is calculated by the control unit 1 by multiplying the velocity magnitude data VB of the ball by the modification coefficient γ. Accordingly, it is possible to display the ball character moving at the velocity set by the velocity magnitude data of the ball on the television monitor 20.

### INDUSTRIAL APPLICABILITY

According to the present invention, with a controller in which an acceleration sensor is embedded, it is possible to cause an object to move based on the acceleration data detected by the acceleration sensor embedded in the controller, and to cause an area associated with the object to change in conjunction with movement of the object.

The terms of degree such as “substantially”, “about” and “approximately” as used herein mean a reasonable amount of deviation of the modified term such that the end result is not significantly changed. These terms should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

1. A computer readable medium storing a computer program for a video game in which a first object and an area changing in conjunction with movement of the first object are displayed, the computer program comprising:
code for recognizing acceleration of an input unit;
code for recognizing time duration of the acceleration;
code for calculating speed of the input unit based on the acceleration and the time duration;
code for calculating speed of the first object based on the speed of the input device;
code for recognizing range of the area;
code for displaying the area on an image display unit on the basis of the range;
code for modifying the range to modified range on the basis of the speed of the first object;
code for displaying the area on the image display unit on the basis of the modified range; and
code for displaying the first object moving at the speed of the object on the image display unit.

2. The computer readable medium claim 1, wherein
the code for modifying the range to the modified range, includes code for narrowing the range on the basis of the speed of the first object if the speed of the first object is greater than reference speed, and
the code for modifying the range to the modified range, includes code for expanding the range on the basis of the speed of the first object if the speed of the first object is less than the reference speed.

3. The computer readable medium according to claim 2, wherein
the code for modifying the range to the modified range, includes code for modifying the range to the modified range on the basis of a ratio of the speed of the first object to the reference speed.

4. The computer readable medium according to claim 1, further comprising
code for recognizing a position of a second object;
code for recognizing velocity of the second object when in motion;
code for judging whether or not the second object overlaps at least part of the modified range of the area;
code for modifying the velocity of the second object to modified velocity on the basis of the distance between a reference point of the area and a reference point of the second object, when the second object overlaps at least part of the modified range of the area;
code for displaying the second object at the modified velocity on the image display unit.

5. The computer readable medium according to claim 4, wherein
the code for modifying the velocity of the second object to the modified velocity includes code for modifying the velocity of the second object to the modified velocity on the basis of the speed of the first object.

6. A video game device of a video game in which an object and an area changing in conjunction with movement of the object are displayed, the video game device comprising:
an acceleration data recognizing unit configured to recognize acceleration of an input unit;
a time duration data recognizing unit configured to recognize time duration of the acceleration;
a speed data calculating unit configured to calculate speed of the input unit based on the acceleration and the time duration;
an object moving speed data calculating unit configured to calculate speed of the object based on the speed of the input device;
a range data recognizing unit configured to recognize range of the area;
a range displaying unit configured to display the area on an image display unit on the basis of the range;
a range data modifying unit configured to modify the range to modified range on the basis of the speed of the object;
a modified area displaying unit configured to display the area on the image display unit on the basis of the modified range; and
an object moving state displaying unit configured to display the first object moving at the speed of the object on the image display unit.

7. Method for controlling a video game in which a first object and an area changing in conjunction with movement of the first object are displayed, the computer program comprising:
recognizing acceleration of an input unit;
recognizing time duration of the acceleration;
calculating speed of the input unit based on the acceleration and the time duration;
calculating speed of the first object based on the speed of the input device;
recognizing range of the area;
displaying the area on an image display unit on the basis of the range;
modifying the range to modified range on the basis of the speed of the first object;
displaying the area on the image display unit on the basis of the modified range; and
displaying the first object moving at the speed of the object on the image display unit.
